(19) United States
(12) Patent Application Publication
(10) Pub. No.: US 2020/0173092 A1
(43) Pub. Date: Jun. 4, 2020

(54) FRONT DOOR ASSEMBLY OF DRUM WASHING MACHINE, AND DRUM WASHING MACHINE

(71) Applicant: QINGDAO HAIER WASHING MACHINE CO., LTD., Qingdao, Shandong (CN)

(72) Inventors: Yuliang JIANG, Qingdao (CN); Jing'en FAN, Qingdao (CN); Risheng SU, Qingdao (CN)

(21) Appl. No.: 16/614,717

(22) PCT Filed: May 18, 2018
(86) PCT No.: PCT/CN2018/087468

§ 371 Date: Nov. 18, 2019

(30) Foreign Application Priority Data
May 18, 2017 (CN) 201710354780.3

(51) Int. Cl. D06F 37/28; E06B 7/30

(52) U.S. Cl. CPC D06F 37/28; E06B 7/30

(57) ABSTRACT

Provided are a front door assembly of a drum washing machine and a drum washing machine. The front door assembly includes an observation bowl glass. The observation bowl glass includes an edge portion, a central portion, and a transition portion connecting the edge portion with the central portion. The central portion protrudes relative to the edge portion. The front door assembly further includes at least one protrusion. The at least one protrusion is arranged at a junction of the central portion and the transition portion. A protruding direction of the at least one protrusion is the same as a protruding direction of the central portion relative to the edge portion.

### CROSS-REFERENCES TO RELATED APPLICATION(S)

This application is United States National Phase application of co-pending International Patent Application Number PCT/CN2018/087468, filed on May 18, 2018 which claims priority to Chinese Patent Application No. 201710354780.3 filed on May 18, 2017, the disclosures of which are incorporated herein by reference in their entireties.

### TECHNICAL FIELD

The present disclosure relates to the technical field of cleaning, for example, a front door assembly of a drum washing machine, and a drum washing machine.

### BACKGROUND

Currently, the drum washing machine has been developed towards being large in volume and diameter. When it comes to the corporation and arrangement of an observation bowl glass and an inner drum, each brand is trying to narrow a size of the observation bowl glass protruding into the inner drum as much as possible, so as to increase a volume of the inner drum.

However, by such arrangement in which the size of the observation bowl glass protruding into the inner drum is designed to be as small as possible, when the inner drum is filled with the laundry to be washed, the laundry tends to remain between the observation bowl glass and a window pad, resulting in some laundry being not washed clean.

### SUMMARY

Provided are a front door assembly of a drum washing machine and a drum washing machine, which can prevent the laundry from remaining between an observation bowl glass and a window pad.

Provided is a front door assembly of a drum washing machine, including an observation bowl glass and at least one protrusion.

The observation bowl glass includes an edge portion, a central portion, and a transition portion connecting the edge portion with the central portion, and the central portion protrudes relative to the edge portion.

The at least one protrusion is arranged at a junction of the central portion and a transition portion. A protruding direction of the at least one protrusion is the same as a protruding direction of the central portion relative to the edge portion.

In one embodiment, along an extending direction of the junction, maximum sizes of the at least one protrusion protruding at multiple positions of the junction in the protruding direction of the at least one protrusion are the same.

In one embodiment, along an extending direction of the junction, maximum sizes of the at least one protrusion protruding at multiple positions of the junction in the protruding direction of the at least one protrusion are gradually increased.

In one embodiment, the junction includes an upper section and a lower section connecting to each other. The upper section is located above the lower section, and the protrusion is arranged on the upper section.

In one embodiment, the transition portion includes a sub-transition section, and the sub-transition extends to the edge portion from the upper section along a linear direction.

In one embodiment, a plurality of protrusions are provided and distributed on two sides of the sub-transition section.

In one embodiment, the central portion is provided with a recess portion recessed towards a direction opposite to a protruding direction of the central portion.

In one embodiment, the at least one protrusion is integrally formed with the observation bowl glass.

Provided is a drum washing machine, including a body and a front door assembly described above. The front door assembly is connected to the body.

In one embodiment, the drum washing machine further includes the body and a window pad. The body is provided with a laundry pick-and-place port, the window pad is connected to the body. And the observation bowl glass is sealingly engaged with the window pad in condition that the laundry pick-and-place port is closed by the front door assembly.

Provided is a front door assembly for a drum washing machine, including an observation bowl glass and at least one protrusion. The at least one protrusion is arranged at a junction of a central portion and a transition portion of the observation bowl glass, and a protruding direction of the protrusion is the same as a protruding direction of the central portion relative to an edge portion. In this way, when a drum inside the washing machine is rotated, the drum drives the laundry to rotate inside the drum. A moving trajectory of the laundry is a determined due to the restriction of an inner wall of the observation bowl glass. Since the protrusion protrudes towards an inside of the drum, the protrusion applies a blocking force to the laundry when the laundry is rotated to the protrusion. The blocking force changes the original moving trajectory of the laundry, so that the laundry moves towards the inside of the drum, thereby preventing the laundry from entering a slit between the observation bowl glass and a window pad and avoiding the laundry from remaining between the observation bowl glass and the window pad.

### BRIEF DESCRIPTION OF DRAWINGS

FIG. 1 is a schematic diagram illustrating an observation bowl glass provided by the embodiments of the present disclosure.

FIG. 2 is a schematic diagram illustrating a partial structure of a drum washing machine provided by the embodiments of the present disclosure.

### DRAWING REFERENCE NUMERALS

1—front door assembly; 11—front door body; 12—observation bowl glass; 121—edge portion; 122—central portion; 1221—recess portion; 123—transition portion; 1231—sub-transition section; 124—junction; 124a—upper section; 124b—lower section; 13—rotary hinge assembly; 14—handle; 15—protrusion;
2—drum;
3—window pad.

Accompanying drawings herein are incorporated in and constitute a part of the present specification, illustrate embodiments consistent with the present disclosure, and serve to explain the present disclosure in conjunction with the specification.

### DETAILED DESCRIPTION

Hereinafter the present disclosure will be described in conjunction with accompanying drawings and specific embodiments.

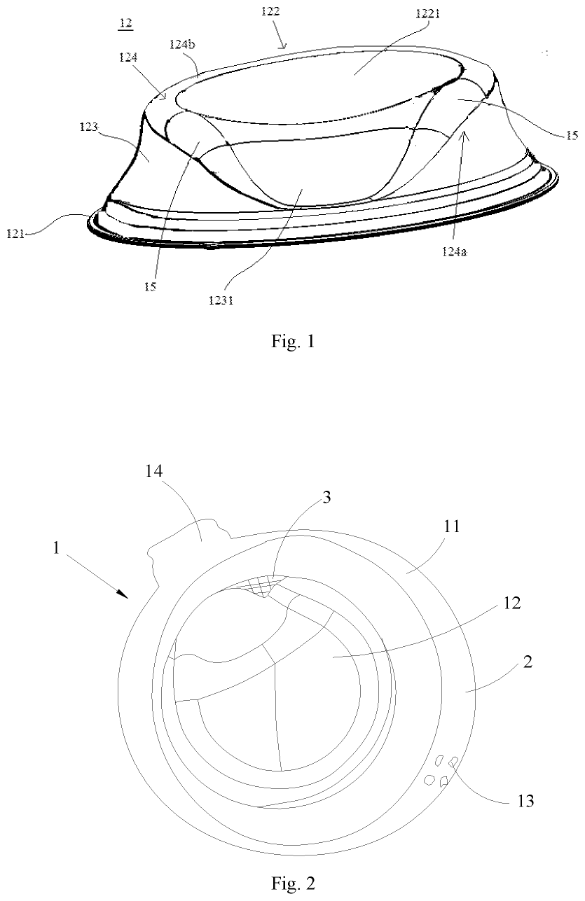

As shown in FIG. 1 to FIG. 2, provided is a front door assembly of a drum washing machine. The front door assembly 1 includes a front door body 11 and an observation bowl glass 12. The observation bowl glass 12 is mounted on the front door body 11 and configured to observe a laundry washing condition inside a drum 2 therethrough. As shown in FIG. 2, the front door assembly 1 is hingedly connected to a body of the drum washing machine through a rotary hinge assembly 13. A handle 14 is arranged on a position of the front door body opposite to the rotary hinge assembly so as to facilitate the opening and closing of the front door assembly 1.

The observation bowl glass 12 includes an edge portion 121, a central portion 122, and a transition portion 123 connecting the edge portion 121 and the central portion 122. In one embodiment, the edge portion 121 is mounted with the front door assembly 11, and the central portion 122 protrudes relative to the edge portion 121.

In addition, the front door assembly 1 further includes at least one protrusion 15 arranged at a junction 124 of the central portion 122 and the transition portion 123. A protruding direction of the protrusion 15 is the same as a protruding direction of the central portion 122 relative to the edge portion 121. When the observation bowl glass 12 is mounted on the front door body 11, the central portion 122 protrudes towards an inside of the drum 2.

According to the above description, when the drum 2 inside the washing machine is rotated, the drum 2 drives the laundry to rotate inside the drum 2. A moving trajectory of the laundry is determined due to the restriction of an inner wall of the observation bowl glass 12. Since the protrusion 15 protrudes towards the inside of the drum 2, the protrusion 15 applies a blocking force to the laundry when the laundry is rotated to a position where the protrusion 15 is. The blocking force changes the original moving trajectory of the laundry, so that the laundry moves towards the inside of the drum 2, thereby preventing the laundry from entering a slit between the observation bowl glass 12 and a window pad 3 and avoiding the laundry from remaining between the observation bowl glass 12 and the window pad 3.

A structure of the protrusion 15 may be selectively arranged according to the actual situations. In one embodiment, along an extending direction of the junction 124, maximum sizes of the at least one protrusion 15 protruding at multiple positions of the junction 124 are the same, that is, at multiple positions of the junction 124, the maximum sizes of the protrusion 15 protruding along the protruding direction are the same. The structure of the observation bowl glass 12 is relatively simple and easy to be processed. In another embodiment, along the extending direction of the junction 124, the maximum sizes of the at least one protrusion 15 protruding at multiple positions of the junction 124 is gradually increased, that is, at multiple positions of the junction 124, the maximum sizes of the protrusion 15 protruding along the protruding direction are different. In this way, the laundry may be gradually moved away from the observation bowl glass 12 during the rotation of the laundry, and be avoided from being remained between the observation bowl glass 12 and the window pad 3.

In addition, during the washing process, the laundry tends to remain between a lower portion of the observation bowl glass 12 and the window pad 3 under the action of gravity, and a situation that the laundry remains between an upper portion of the observation bowl glass 12 and the window pad 3 rarely occurs. In view of the factor, in the present embodiment, the protrusion 15 is arranged at the following position. The junction 124 is provided with an upper section 124a and a lower section 124b. The upper section 124a is arranged above the lower section 124b. The protrusion 15 is arranged on the upper section 124a. In this way, when the laundry is rotated to the upper portion of the observation bowl glass 12, the protrusion 15 on the upper section 124a applies a force to the laundry and the force changes the moving trajectory of the laundry, so that the laundry moves to the inside of the drum 2, thereby preventing the laundry from remaining.

In one embodiment, as shown in FIG. 1, the transition portion 123 includes a sub-transition section 1231. The sub-transition section 1231 extends to the edge portion 121 from the upper section 124a along a linear direction. The sub-transition section 1231 enables an accommodating space to be formed between the observation bowl glass 12 and the drum 2. The accommodating space may accommodate more laundry and increase a volume inside the drum 2.

In one embodiment, as shown in FIG. 1, a plurality of protrusions 15 are provided and distributed on two sides of the sub-transition section 1231. In this way, during the rotation of the laundry, the plurality of protrusions 15 may apply the force to the laundry at the same time, so that the laundry is more reliably moved into the drum 2 and avoided from being remained.

In one embodiment, the volume inside the drum may be increased in the following manners. As shown in FIG. 1, the central portion 122 further includes a recess portion 1221 which is recessed towards a direction opposite to the protruding direction of the central portion 122. By arranging the recess portion 1221, an external space may be converted into the washing drum, thereby increasing the volume inside the washing machine.

In the above description, the protrusion 15 may be separately arranged or integrally formed with the observation bowl glass 12. In the present embodiment, the protrusion 15 and the observation bowl glass 12 are integrally formed, and processes in the same process. The processing scheme is simple and the processing cost is low.

Further provided is a drum washing machine, including a body and a front door assembly 1 connected to the body. The front door assembly 1 may be provided by any one of the above embodiments.

The drum washing machine includes the body and a window pad 3. The body is a frame of the washing machine. A plurality of components are mounted on the body. The window pad 3 is used as a sealing component and mounted on the body. The body is provided with a laundry pick-and-place port. The window pad 3 extends along the laundry pick-and-place port. The front door assembly 1 is mounted on the body. When the laundry pick-and-place port is closed by the front door assembly 1, the observation bowl glass 12 is sealingly engaged with the window pad 3, so that the laundry and washing water are sealed inside the drum.

For the drum washing machine provided by the present embodiment, when the drum inside the washing machine is rotated, the drum drives the laundry to rotate inside the drum. A moving trajectory of the laundry is a determined due to the restriction of an inner wall of the observation bowl glass. Since the protrusion protrudes towards the inside of the drum, the protrusion applies a blocking force to the laundry when the laundry is rotated to a position where the protrusion is. The blocking force changes the original moving trajectory of the laundry, so that the laundry moves towards the inside of the drum, thereby preventing the laundry from entering a slit between the observation bowl glass and a window pad and avoiding the laundry from remaining between the observation bowl glass and the window pad.

Provided are a front door assembly for a drum washing machine and a drum washing machine. The front door assembly includes an observation bowl glass and at least one protrusion. The at least one protrusion is arranged at a junction of a central portion and a transition portion of the observation bowl glass, and a protruding direction of the protrusion is the same as a protruding direction of the central portion relative to an edge portion. Since the protrusion protrudes towards an inside of a drum, the protrusion applies a blocking force to the laundry when the drum inside the washing machine is rotated. The blocking force changes the original moving trajectory of the laundry, so that the laundry moves towards the inside of the drum, thereby preventing the laundry from entering a slit between the observation bowl glass and a window pad and avoiding the laundry from remaining between the observation bowl glass and the window pad.

1. A front door assembly of a drum washing machine, comprising an observation bowl glass and at least one protrusion, wherein
the observation bowl glass comprises an edge portion, a central portion, and a transition portion connecting the edge portion with the central portion, the central portion protrudes relative to the edge portion; and
the at least one protrusion is arranged at a junction of the central portion and the transition portion, a protruding direction of the at least one protrusion is the same as a protruding direction of the central portion relative to the edge portion.

2. The front door assembly according to claim 1, wherein along an extending direction of the junction, maximum sizes of the at least one protrusion protruding at multiple positions of the junction in the protruding direction of the at least one protrusion are the same.

3. The front door assembly according to claim 1, wherein along an extending direction of the junction, maximum sizes of the at least one protrusion protruding at multiple positions of the junction in the protruding direction of the at least one protrusion are gradually increased.

4. The front door assembly according claim 1, wherein the junction comprises an upper section and a lower section connecting to each other, the upper section is located above the lower section, and the protrusion is arranged on the upper section.

5. The front door assembly according to claim 4, wherein the transition portion comprises a sub-transition section, and the sub-transition section extends to the edge portion from the upper section along a linear direction.

6. The front door assembly according to claim 5, wherein a plurality of protrusions are provided and distributed on two sides of the sub-transition section.

7. The front door assembly according to claim 1, wherein the central portion is provided with a recess portion recessed towards a direction opposite to a protruding direction of the central portion.

8. The front door assembly according to claim 1, wherein the at least one protrusion is integrally formed with the observation bowl glass.

9. A drum washing machine, comprising a body and a front door assembly, wherein the front door assembly is connected to the body, and the front door assembly comprises an observation bowl glass and at least one protrusion, wherein
the observation bowl glass comprises an edge portion, a central portion, and a transition portion connecting the edge portion with the central portion, the central portion protrudes relative to the edge portion; and
the at least one protrusion is arranged at a junction of the central portion and the transition portion, a protruding direction of the at least one protrusion is the same as a protruding direction of the central portion relative to the edge portion.

10. The drum washing machine according to claim 9, further comprising a window pad, wherein the body is provided with a laundry pick-and-place port, the window pad is connected to the body, and the observation bowl glass is sealingly engaged with the window pad in condition that the laundry pick-and-place port is closed by the front door assembly.

11. The front door assembly according to claim 2, wherein the junction comprises an upper section and a lower section connecting to each other, the upper section is located above the lower section, and the protrusion is arranged on the upper section.

12. The front door assembly according to claim 3, wherein the junction comprises an upper section and a lower section connecting to each other, the upper section is located above the lower section, and the protrusion is arranged on the upper section.

13. The front door assembly according to claim 2, wherein the central portion is provided with a recess portion recessed towards a direction opposite to the protruding direction of the central portion.

14. The front door assembly according to claim 3, wherein the central portion is provided with a recess portion recessed towards a direction opposite to the protruding direction of the central portion.

15. The front door assembly according to claim 2, wherein the at least one protrusion is integrally formed with the observation bowl glass.

16. The front door assembly according to claim 3, wherein the at least one protrusion is integrally formed with the observation bowl glass.

17. The drum washing machine according to claim 9, wherein along an extending direction of the junction, maximum sizes of the at least one protrusion protruding at multiple positions of the junction in the protruding direction of the at least one protrusion are the same.

18. The drum washing machine according to claim 9, wherein along an extending direction of the junction, maximum sizes of the at least one protrusion protruding at multiple positions of the junction in the protruding direction of the at least one protrusion are gradually increased.

19. The drum washing machine according to claim 9, wherein the junction comprises an upper section and a lower section connected to each other, the upper section is located above the lower section, and the protrusion is arranged on the upper section.

20. The drum washing machine according to claim 19, wherein the transition portion comprises a sub-transition section, and the sub-transition section extends to the edge portion from the upper section along a linear direction.
